(19) United States
(12) Patent Application Publication
(10) Pub. No.: US 2013/0216324 A1
(43) Pub. Date: Aug. 22, 2013

(54) VEHICLE TIE DOWN SYSTEM USING WIRE GRATE

(71) Applicant: Richard A. Tatina, Countryside, IL (US)

(72) Inventor: Richard A. Tatina, Countryside, IL (US)

(21) Appl. No.: 13/398,265

(22) Filed: Feb. 16, 2012

(51) Int. Cl. B60P 3/075

(52) U.S. Cl. 410/3

(57) ABSTRACT

In a vehicle tie down system and method for securing a vehicle to a wire grate, a strap is positioned over and around a portion of the vehicle tire. A connection assembly connects to a first end of the strap. A winch assembly connects to an opposite second end of the strap. Both the connection assembly and the winch assembly have a frame, a hook member, a grate lock member, and a gravity lock member. The winch assembly also has a mandrel and a mandrel locking unit.

### BACKGROUND

Rail cars, and particularly bi-level rail cars, are equipped with mesh wire grates to which vehicles such as automobiles and trucks are secured during transport on the rail cars. The preferred method of securing the vehicles on such rail cars has been with chocks such as shown in U.S. Pat. Nos. 5,302,063 and 5,312,213 commonly referred to as “Holden Chocks”.

The introduction of short wheel-base high center of gravity “cross-over” vehicles has resulted in a great number of instances of vehicles jumping the chocks. In recent years, there has been an effort by the railroads, auto manufacturers, and suppliers to develop tie down systems to halt the increased incidences of jumped chocks.

Recently, other systems with chocks have been developed such as shown in U.S. Pat. No. 6,851,523 and U.S. Published Application 2008/0232919. Also, a product manufactured by the Holland Company is known comprised of a chock with a self-retracting strap and hook.

All the known systems currently in use combine plastic and steel parts, and are large and weigh as much as 12 pounds. Only the Holland Company device incorporates a strap over the tire to restrain vertical movement of the tires associated with the vehicles.

A winch for tightening a strap is illustrated, for example, in design U.S. Pat. No. 346,258.

Previous chock designs have not taken into consideration the industry's field consumption requirements wherein underbody and wheel rail clearance have been reduced making it difficult to install the large wheel chocks. Ideally, a tie down should work in an area defined by a vertical tangent to the tire. But again, the device should have as low a profile as possible.

### SUMMARY

It is an object to provide a tie down system for securing vehicles to wire grates for transport with a system which will prevent jumped chocks, is convenient to use, is relatively inexpensive, and is reliable, but which is compatible with the use of existing wire grates.

In a vehicle tie down system and method for securing a vehicle to a wire grate, a strap is positioned over and around a portion of the vehicle tire. A connection assembly connects to a first end of the strap. A winch assembly connects to an opposite second end of the strap. Both the connection assembly and the winch assembly have a frame, a hook member, a grate lock member, and a gravity lock member. The winch assembly also has a mandrel and a mandrel locking unit.

### BRIEF DESCRIPTION OF THE DRAWINGS

FIG. 1 is a side view of a vehicle tie down system useful with a wire grate;

FIG. 2 is a top view of the system shown in FIG. 1;

FIG. 3 is a side view of a winch assembly of the tie down system of FIG. 1;

FIG. 4 is a top view of the winch assembly of FIG. 3;

FIG. 5 is an end view of the winch assembly from the right side of FIGS. 3 and 4;

FIG. 6 is a side view of a clevis assembly used in the vehicle tie down system of FIG. 1;

FIG. 7 is a top view of the clevis assembly of FIG. 6;

FIG. 8 is an end view of the clevis assembly from the left side of FIGS. 6 and 7;

FIG. 9A is a front view of a grate lock member separate and apart from the winch assembly (the same part but with different reference numerals is also used in the clevis assembly);

FIG. 9B is a top view of the grate lock member of FIG. 9A;

FIG. 10A is a side view of a gravity lock member of the winch assembly (the same part but with different reference numerals is also used in the clevis assembly);

FIG. 10B is a top view of the gravity lock member of FIG. 10A;

FIGS. 11A, 11B, and 11C are progressive side views showing method steps in the securement of the winch assembly shown in FIG. 1 onto the wire grate; and

FIGS. 12A, 12B and 12C are progressive side views showing method steps in the securement of the clevis assembly shown in FIG. 1 onto the wire grate.

### DESCRIPTION OF PREFERRED EXEMPLARY EMBODIMENT

For the purposes of promoting an understanding of the principles of the invention, reference will now be made to the preferred exemplary embodiment/best mode illustrated in the drawings and specific language will be used to describe the same. It will nevertheless be understood that no limitation of the scope of the invention is thereby intended, and such alterations and further modifications in the illustrated embodiment and such further applications of the principles of the invention as illustrated as would normally occur to one skilled in the art to which the invention relates are includes.

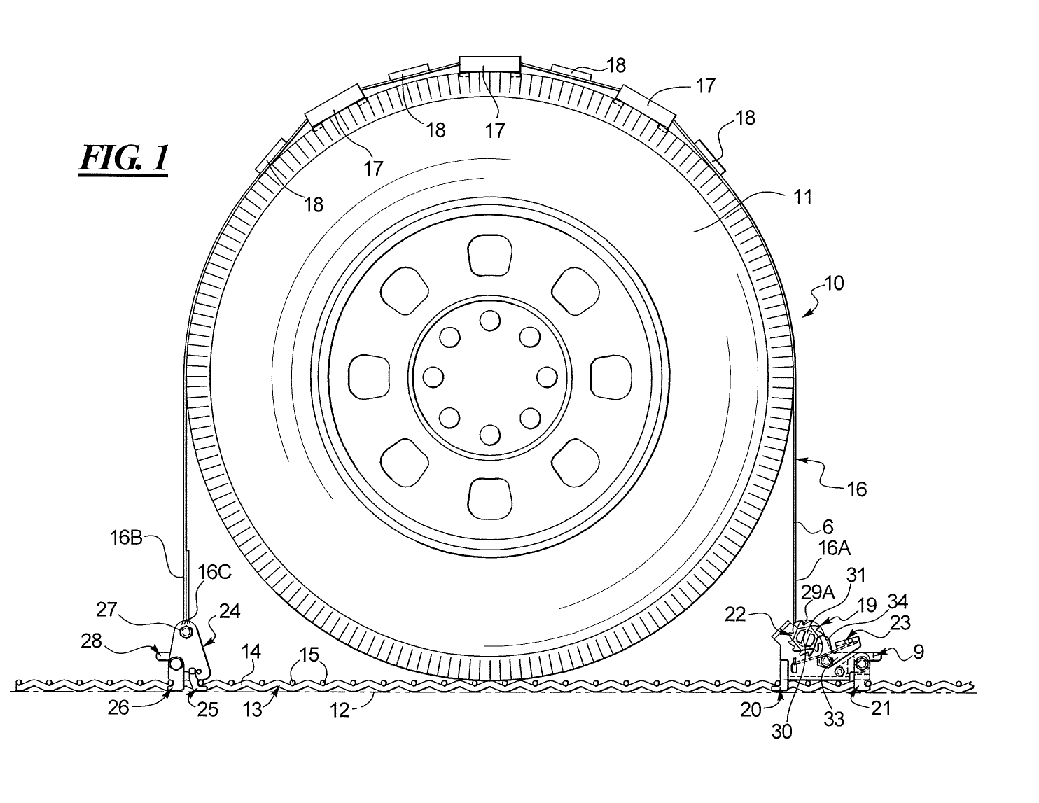

The vehicle tie down system of the present exemplary preferred embodiment is generally shown at 10 in FIG. 1. A vehicle tire 11 attached to a vehicle which is to be secured rests on top of a mesh-like wire grate 13 resting on a support surface 12, and is formed of longitudinal grate wires 14 and transverse lateral grate wires 15. A strap assembly 16 formed of a strap 6 with cleats 17 and pads 18 partially surround a periphery of the tire. One end 16A of the strap 6 attaches to a winch assembly 19 which is locked to the grate 13. An opposite end 16B of the strap 6 has a loop 16C which loops around a clevis pin 27 of a clevis assembly 24. The clevis assembly 24 is also locked to the wire grate 13. When a mandrel assembly 22 of the winch assembly 19 is tightened, such as by a socket wrench, the strap assembly 16 is tightened around the tire 11. A pawl arm 33 of a pawl unit 23 can be pressed down to release the mandrel assembly 22 by disengaging a respective pawl tooth 34A, B from serrations 29A of respective gears 29A, 29B at opposite ends of the mandrel so that a mandrel 30 of mandrel assembly 22 can turn. The mandrel 30 has a slot 31 for receiving the end 16A of the strap 6 such that the end 16A of the strap is wound around the mandrel 30 for securement.

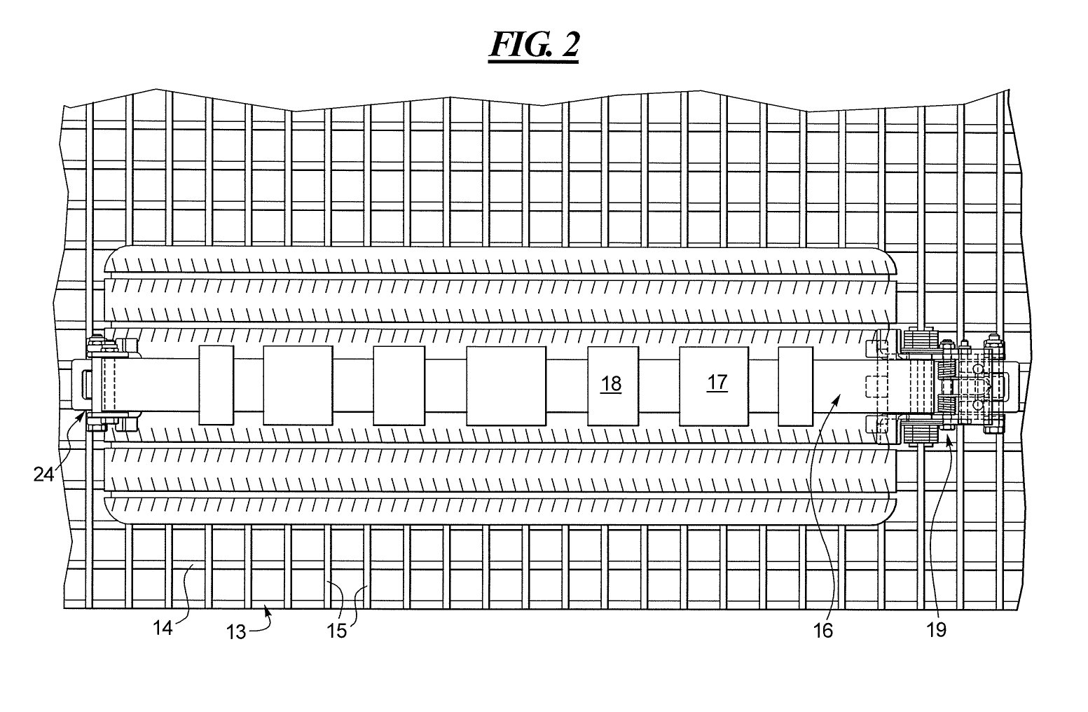

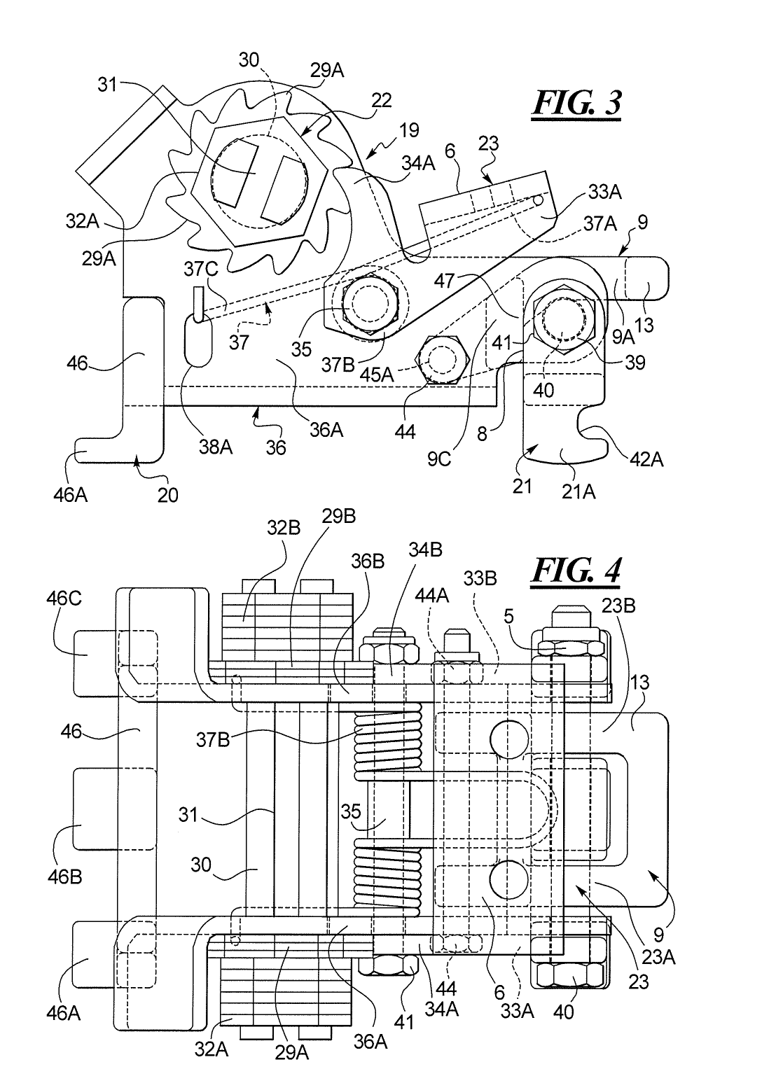

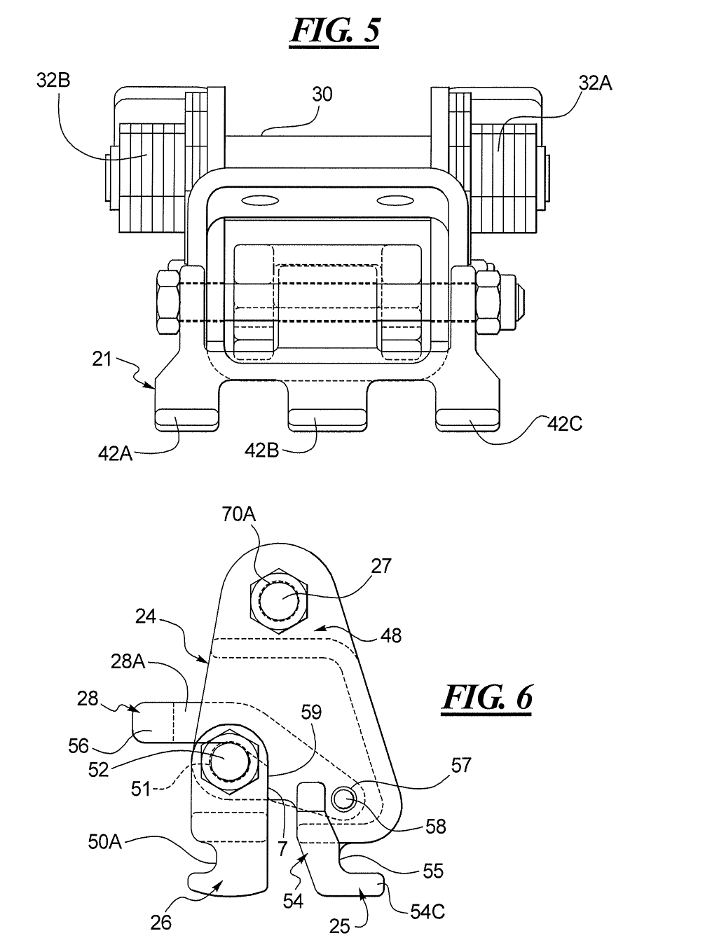

As shown in FIG. 1 but as will also be explained with reference to FIGS. 3-5, the winch assembly 19 has a grate lock member 21 and a front hook member 20 for engaging with respective grate wires 15 of the wire grate 13. A gravity lock member 9 is also provided to lock the grate lock member 21 in place as explained hereafter.

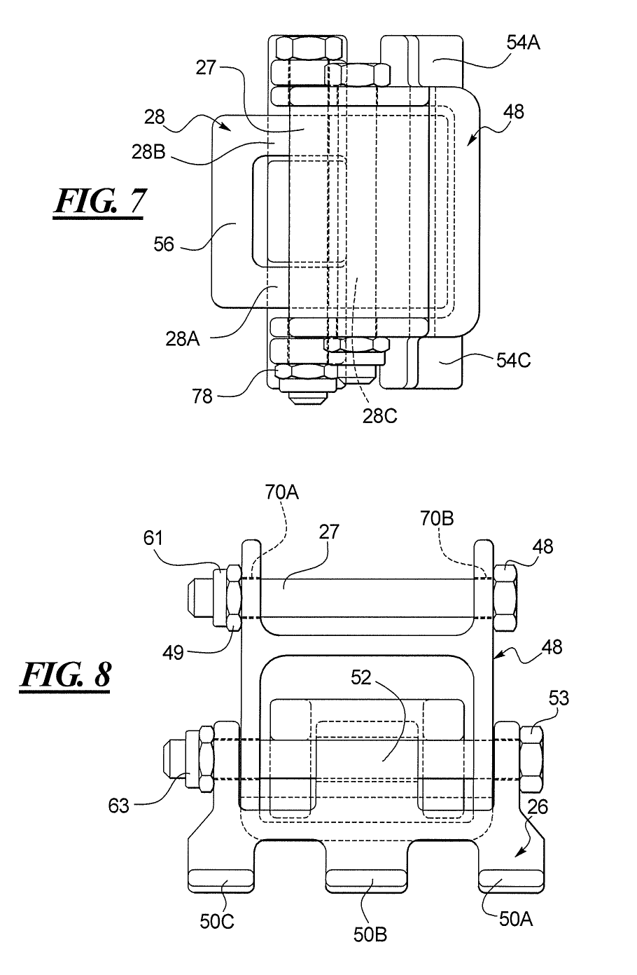

As also shown in FIG. 1 but as further explained in FIGS. 6, 7, and 8, the clevis assembly 24 also has a grate lock member 26, a front hook member 25, and a gravity lock member 28. The front hook member 25 and the grate lock member 26 engage respective grate wires 15 as explained further hereafter. The gravity lock member 28 prevents movement of the grate lock member 26 when engaged against member 26.

Further details of the winch assembly 19 will now be explained with reference to FIGS. 3, 4 and 5.

The winch assembly 19 has the mandrel assembly 22 formed of the mandrel 30 with the slot 31. A gear 29 with gear serrations 29A is connected at each opposite side of the mandrel. Outer ends of the mandrel have hexagonal members 32A and 32B for receiving the socket wrench at either side. The mandrel assembly 19 is retained in respective apertures in side walls of a winch frame 36.

The pawl unit 23 has two pawl arms 33A, B and the respective pawl tooth 34A, B, and rotates about a bolt 35. Pawl unit 23 is spring biased by a spring member 37 having one end 37A biased against a push surface 6 on pawl arm 33. The spring is wound as shown by winding 37B around the same bolt 35 which retains the pawl unit 23. The opposite end 37C of the spring member 37 engages in a retention slot 38A or 38B in respective sidewalls 36A and 36B of a frame. When pressed down, the bottom surface of the push surface 6 hits side portions of frame 36.

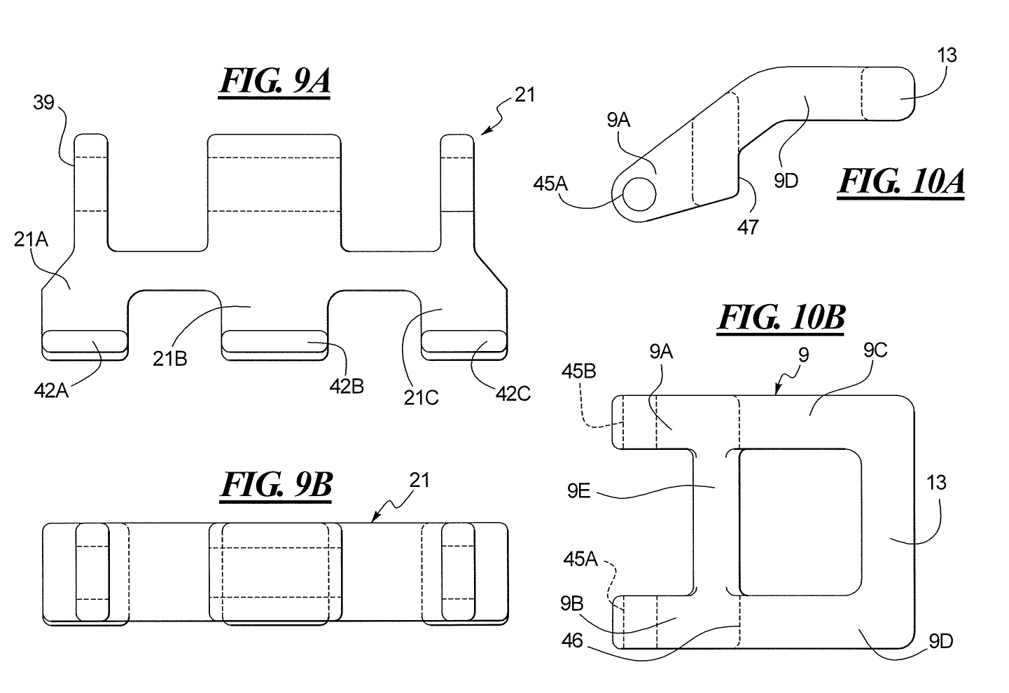

Grate lock member 21 (also shown in separate detail in FIGS. 9A and 9B) is attached by a bolt 40 having a securement locknut 5 through sidewalls 36A, 36B of frame 36 for pivoting operation. The grate lock member 21 attaches to the bolt 40 at an aperture 39. The grate lock member 21 has three grate wire engagement notches 42A, B, C on respective protrusion portions 21A, B, C.

The front lock member 21 has three hook portions 46A, 46B, and 46C which are integral with a base member 46 which is a separate piece attached to the frame 36, such as by welding.

The gravity lock member 9 is shaped like the letter “D” with two ears 9A, B for mounting, and as shown most clearly in FIGS. 10A and 10B has a handle portion 13 at one end, side portions 9C, 9D a bridge portion 9E and an abutment surface 47 for engaging against a back surface 8 of the grate lock member 21, and pivots at apertures 45A, B about a bolt 44 secured with a locknut 44A.

Details of the clevis assembly 24 are illustrated in FIGS. 6, 7, and 8. The clevis assembly 24 has a frame 48 having apertures 70A, B for receiving the clevis pin 27 comprising a bolt passing through apertures 70A, B in the frame 48 and secured by a locknut 49. The grate lock member 26 (which has the same construction as grate lock member 21 of the winch assembly) has grate wire engagement notches 50A, B, C and is secured at an aperture 51 for free rotation about a bolt 52 secured by lock nut 63. The gravity lock member 28 (which has the same construction as gravity lock member 9 of the winch assembly) has a handle portion 56 at one end and which rotates about a bolt 58 received through respective apertures in frame 48. The gravity lock member 28 has an abutment surface 59 for abutting against a back surface 7 of lock member 26 when in the locking position. A front hook member 25 has hook portions 54A, 54B, 54C of base member portion 54 which is integral with frame 48 and a wire grate engagement surface 55 of base member 54.

A mounting engagement of the winch assembly 19 at any desired position on the wire grate 13 resting on support surface 12 will now be described with respect to FIGS. 11A, 11B, and 11C. In FIG. 11A, the gravity lock member 9 is raised by its handle portion 13, thus allowing rearward pivoting of the front hook member 20. By tilting the winch assembly 19, the hook portions 46A, 46B, 46C can engage with a wire 15A of the wire grate 13.

As shown in FIG. 11B, the winch assembly 19 is now tilted down until it rests on the wires 15 of the grate 13. Then, as shown in FIG. 11C, the gravity lock member 9 is released which then pushes the grate lock member 21 such that the engagement notches 42A, B, C engage with a grate wire 15B. In this position, abutment surface 47 of the gravity lock member 9 abuts against the back surface 8 of the grate hook member 21 and thus locks it in place.

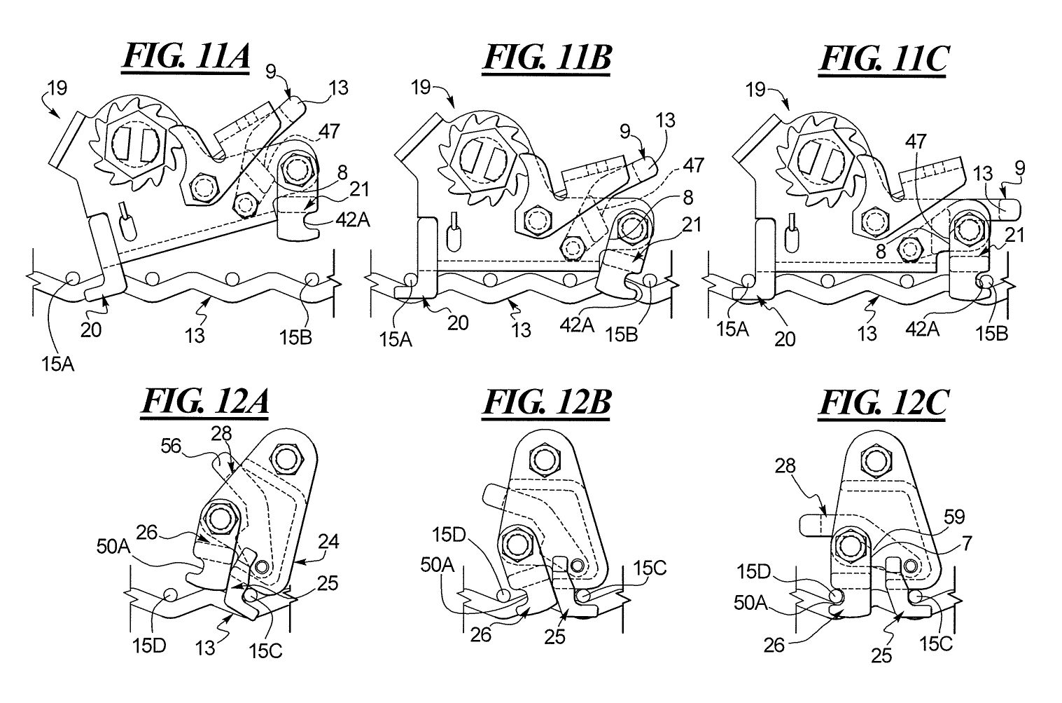

The clevis assembly 24 engages with the grate 13 in similar fashion as illustrated in FIGS. 12A, 12B, and 12C.

As shown in FIG. 12A, the clevis assembly 24 is tilted back towards the vehicle tire so that the hook member 25 engages the transverse grate wire 15C. While this is occurring the operator pulls the gravity lock member 28 upwardly by use of handle portion 56, thus allowing grate lock member 26 to be rotated back away from the tire. As shown in FIG. 12B, the clevis assembly 28 is then rotated down into a horizontal position. Thereafter in FIG. 12C, handle portion 56 of the gravity lock member 28 is pushed downwardly or falls by gravity which causes the contact of the abutment surface 59 of the gravity lock member 28 to contact the back surface 7 of the grate lock member 26 forcing the bottom end where the grate notches 50A, B, C are located to move forwardly away from the tire to engage transverse grate wire 15D in a locked position.

After the clevis assembly and winch assembly have been locked in position, strap assembly 16 is threaded over the tire 11 and the end 16A of strap 6 is threaded into the mandrel slot 31. The mandrel is then turned on the winch assembly in a counterclockwise direction for the arrangement of FIG. 1 to tighten the end of the web 16A against itself as it winds on the mandrel. The pawl tooth 34A or 34B engages in the serrations of the gear 29A or 29B attached to opposite ends of the mandrel 30 to hold it in a position to maintain tension on the strap assembly 16.

As may be appreciated, the tie down system is adaptable for different sized tires since the winch assembly and clevis assembly may be located and engaged at appropriate locations depending on the size of the tire. Thus, the vehicle may be secured to the grate at various locations in view of the flexibility connection of placement and engagement of the winch assembly and clevis assembly on the grate.

The tie down system also prevents chock jump by the tire by use of the strap assembly.

The tie down system is easy to operate in view of its simplicity. Also, reliability is improved in view of the relatively small number of moving parts involved in the system.

The design of the clevis assembly and winch assembly is simplified allowing reduced manufacturing and material costs.

Alternative designs may be employed for securing the mandrel rotation and for releasing the mandrel.

Preferably, the winch assembly overlies approximately four of the transverse grate wires when locking to the first and fourth grate wires while resting on the second and third transverse grate wires. However, the longitudinal dimensions of the winch assembly may vary to encompass a different number of the grate wires.

Preferably, the clevis assembly utilizes two adjacent transverse grate wires. However, longitudinal dimensions of the clevis assembly could vary to overlie more than two grate wires.

Further changes may be made to the strap assembly, winch assembly, and clevis assembly such as in the shape of the gravity lock member, grate lock member, and hook member of the winch assembly or clevis assembly.

The clevis assembly, grate, and winch assembly may be constructed primarily of steel parts, although in some applications, some or more of the parts may comprise harden plastics or other materials.

The strap assembly 16 preferably employs a polyester webbing or strap 6 although potentially other materials may be employed. A width of the webbing is approximately 2 inches. This may vary in a range from 1 inch to 4 inches.

Although a preferred exemplary embodiment is shown and described in detail in the drawings and in the preceding specification, it should be viewed as purely exemplary and not as limiting the invention. It is noted that only a preferred exemplary embodiment is shown and described, and all variations and modifications that presently or in the future lie within the protective scope of the invention should be protected.

I claim as my invention:

1. A vehicle tie down system for securing a vehicle by securing at least one tire of the vehicle to a wire grate having lateral grate wires and transverse lateral grate wires forming a mesh, comprising:
a strap dimensioned for positioning over and around a portion of the vehicle tire;
a clevis assembly for connection to a first end of said strap;
a winch assembly for connection to an opposite second end of said strap;
the winch assembly having a frame with a mandrel, a pawl unit, a hook member, a grate lock member, and a gravity lock member, said hook member being fixed non-moveably to said frame and having a grate wire engagement portion for engaging a first of said lateral grate wires, said grate lock member having a grate wire engagement portion for engaging a second of said lateral grate wires and being rotatably connected to said frame, said gravity lock member being rotatably connected to said frame and having a handle and an abutment surface for abutting against said grate lock member, said pawl unit being rotatably mounted to said frame and having a push surface and a tooth for engagement with serrations of a gear connected to said mandrel, said mandrel being rotatably mounted to said frame; and
the clevis assembly having a frame, a strap connecting member for engagement with said first end of said strap, a hook member, a grate lock member, and a gravity lock member, said hook member being fixed non-moveably to said frame and having a grate wire engagement portion for engaging a third of said lateral grate wires, said grate lock member having a grate wire engagement portion for engaging a fourth of said lateral grate wires and being rotatably connected to said frame, said gravity lock member being rotatably connected to said frame and having a handle and an abutment surface for abutting against said grate lock member, and said strap connecting member being connected to said frame.

2. The system of claim 1 wherein the grate wire engagement portion of said grate lock member of each of said winch assembly and said clevis assembly comprises a semi-circular notch.

3. The system of claim 1 wherein said grate wire engagement portion of said hook member of each of said winch assembly and said clevis assembly comprises a rounded substantially 90 degree bend hook portion positioned and extending below a flat horizontal bottom portion of said frame.

4. The system of claim 1 wherein said gravity lock member of each said winch assembly and said clevis assembly comprises at least one arm having said handle at one end, a pivoting aperture at an opposite end, said abutment surface intermediate said pivoting aperture and said handle, said abutment surface in a locked position of said gravity lock member being substantially vertical when the winch assembly and the clevis assembly are engaged with the grate wire mesh and butts against a back surface of said grate lock member which is also substantially vertical when locked.

5. The system of claim 1 wherein each of said clevis assembly and said winch assembly grate lock member has at least three spaced apart protrusion portions each with a respective notch.

6. A system of claim 1 wherein said pawl unit has at least one arm with a rotation aperture at an end of said arm opposite said push surface and said tooth extends substantially upwardly from a rotatable supporting member passing through said aperture.

7. The system of claim 6 wherein said pawl unit has two of said teeth and two of said arms and said push surface bridging between said arms, and a spring biasing said pawl unit such that said teeth engage respective gears at opposite ends of said mandrel when said pawl unit is in a locking position for locking said mandrel against rotation.

8. The system of claim 1 wherein said mandrel has at least one socket engagement portion for rotating the mandrel at one end of the mandrel and a slot in the mandrel for receiving said second end of said strap.

9. The system of claim 1 wherein said second end of said strap is a loop and said strap connecting member comprises a bolt passing through said loop.

10. The method of claim 9 wherein said bolt is mounted through opposing apertures in said frame of said clevis assembly.

11. The system of claim 1 wherein the hook member of said clevis assembly comprises an L shaped base portion having at least two extension portions extending downwardly from a flat bottom portion of said frame and hook portions extending from the extension portions at right angles.

12. The system of claim 11 wherein at least three of said extension portions with the corresponding hook portions are provided.

13. The system of claim 1 wherein said grate lock member of both said clevis assembly and said winch assembly has three extension portions each with a respective notch.

14. The system of claim 1 wherein said mandrel has gears at opposite ends of the mandrel.

15. A vehicle tie down system for securing a vehicle by securing at least one tire of the vehicle to a wire grate having grate wires forming a mesh, comprising:
a strap dimensioned for positioning over and around a portion of the vehicle tire;
a connection assembly for connection to a first end of said strap;
a winch assembly for connection to an opposite second end of said strap;
the winch assembly having a frame with mandrel, a mandrel locking unit, a hook member, a grate lock member, and a gravity lock member, said hook member being fixed non-moveably to said frame and having a grate wire engagement portion for engaging a first of said grate wires, said grate lock member having a grate wire engagement portion for engaging a second of said grate wires and being rotatably connected to said frame, said gravity lock member being rotatably connected to said frame and having a handle and a portion for preventing movement of said grate lock member when the gravity lock member is in a locking position, and said mandrel being rotatably mounted to said frame; and
the connection assembly having a frame, a strap connecting member for engagement with said first end of said strap, a hook member, a grate lock member, and a gravity lock member, said hook member being fixed non-moveably to said frame and having a grate wire engagement portion for engaging a third of said grate wires, said grate lock member having a grate wire engagement portion for engaging a fourth of said grate wires and being rotatably connected to said frame, said gravity lock member being rotatably connected to said frame and having a handle and a portion for preventing movement of said grate lock member when the gravity lock member is in a locking position, said strap connecting member being connected to said frame.

16. A method for securing a vehicle by securing at least one tire of the vehicle to a wire grate having grate wires forming a mesh, comprising the steps of:
providing a strap for positioning over and around a portion of the vehicle tire;
providing a connection assembly connected to a first end of said strap;
providing a winch assembly for connection to an opposite second end of said strap;
positioning the connection assembly on said wire grate by rotating the connection assembly away from the tire to engage a hook member fixed to said connection assembly around a first grate wire, rotating the connection assembly down on top of the wire grate mesh while a rotatable gravity lock member of said connection assembly is held by a user in an upwardly position, and then lowering the gravity lock member to lock a rotatable grate lock member of said connection assembly in place in engagement with a second grate wire;
positioning the winch assembly on said wire grate by rotating the winch assembly away from the tire to engage a hook member fixed to said winch assembly around a third grate wire, rotating the winch assembly down on top of a wire grate mesh while a rotatable gravity lock member of said winch assembly is held by a user in an upwardly position, and then lowering the gravity lock member to lock a rotatable grate lock member of said winch assembly in place in engagement with a fourth grate wire; and
connecting a second end of said strap to a rotatable mandrel of said winch assembly, rotating the mandrel to tighten the strap, and then locking the mandrel in place with a locking mechanism of the winch assembly.

17. The method of claim 16 wherein said step of lowering the gravity lock member of said connection assembly and said winch assembly is by gravitational force.

18. The method of claim 16 wherein said step of lowering the gravity lock member of said connection assembly and said winch assembly is by the user pushing down on a handle portion of the gravity lock member.
